(19) United States
(12) Patent Application Publication
(10) Pub. No.: US 2019/0318223 A1
(43) Pub. Date: Oct. 17, 2019

(54) Methods and Systems for Data Analysis by Text Embeddings

(71) Applicant: Georgia Tech Research Corporation, Atlanta, GA (US)

(72) Inventors: Yao Xie, Atlanta, GA (US); Shixiang Zhu, Atlanta, GA (US)

(21) Appl. No.: 16/383,563

(22) Filed: Apr. 12, 2019

Related U.S. Application Data
(60) Provisional application No. 62/656,835, filed on Apr. 12, 2018.

(51) Int. Cl. G06N 3/04; G06F 17/27

(52) U.S. Cl. CPC G06N 3/04; G06N 3/08; G06F 17/27

(57) ABSTRACT

A method for database management is disclosed. The method may include receiving a plurality of crime reports. Field data and/or narrative field data may be extracted from the plurality of crime reports. Further, a plurality of tokens may be generated from the narrative field data. The plurality of tokens may be sent to a neural network. In response, crime prediction data may be received from the neural network. Based on the crime prediction data and field data, related crimes may be determined. The related crimes may be plotted to map. Further, a visual display of the map may be generated. The visual display may be sent to a user portal and the user portal may then display the visual display as a graphical user interface.

### CROSS-REFERENCE TO RELATED APPLICATION

This Application claims the benefit of, and priority under 35 U.S.C. § 119(e) to, U.S. Provisional Patent Application No. 62/656,835, entitled “Online Semantic Analysis by Text Embeddings,” filed Apr. 12, 2018, the contents of which are hereby incorporated by reference herein in their entirety as if fully set forth below.

### FIELD OF THE INVENTION

The presently disclosed subject matter relates generally to methods and systems for data analysis and, more particularly, to methods and systems for identifying and determining correlations amongst data.

### BACKGROUND

A fundamental and one of the most challenging tasks in data analysis is to find correlations within the data. This is especially true within the field of crime analysis where the data is provided via police reports. Each incident has a unique police report, which contains the time, location (e.g., latitude and longitude), and free-text narratives entered by police officers. Free-text narratives often contain the most useful information in an investigation. Despite the wealth of information available in a free-text narrative, the free-text narratives often include incomplete sentences and use different terms to explain similar incidents, as they are typically written in a haste by different police officers. Because crime analysis often seeks to identify related crimes based on observable traces of the actions performed by the perpetrator when executing the crime (modus operandi), identifying correlations amongst the police report data is integral. Manually determining related crimes typically requires extracting various information from police reports of crime incidents, which may be time-intensive, labor-intensive, and/or not scalable. Moreover, attempts to automate crime analysis often only consider time, location, and/or category information.

Accordingly, there is a need for an improved method and system for identifying correlations amongst data and more specifically, determining related crimes amongst a plurality of reports.

### SUMMARY

Aspects of the disclosed technology include methods and systems for data analysis by text embeddings. Consistent with the disclosed embodiments, the methods can include one or more processors, transceivers, user devices, neural networks, computing devices, or databases. In some cases, the methods and systems may include one or more processors receiving reports. In some embodiments, the reports may be crime reports. The field data may be extracted from the crime reports. The method may further include identifying a narrative from amongst each of the reports. The narrative field data may be extracted from the narrative field. The field data and/or narrative field data may include a combination of words and punctuation characters. The method may also include generating a plurality of tokens based on the field data and/or the narrative field data. The plurality of tokens and/or the field data may be sent to a neural network. In response, the neural network may send predictive data to the one or more processors. In some embodiments, the predictive data may be crime prediction data. According to some embodiments, based on the crime prediction data and the field data, related crimes may be determined. The method may plot the related crimes and/or the predictive data to a map, generate a visual display of the map, and send the visual display to a user portal. The user portal may display the visual display as a graphic user interface.

In some embodiments, the field data may include an incident time and/or an incident location.

According to some embodiments, generating the plurality of tokens may include the processor normalizing the narrative field data, such that the plurality of words within the narrative field data are the same case. Further, the processor may remove the plurality of punctuation characters from the narrative field data and convert the narrative field data into the plurality of tokens. Next, the processor may determine an amount of occurrences within the narrative field data for each of the plurality of tokens. The corresponding amount of occurrences may be associated with each of the plurality of tokens. Additionally, a weight of each of the plurality of tokens may be determined based at least in part on the corresponding amount of occurrences. The corresponding weight may also be associated with each of the plurality of tokens.

In some embodiments, each of the plurality of tokens may include a three-word combination.

In some embodiments, the method may further include comparing each of the plurality of tokens to terms within a database for at least a partial match, and calculating an amount of at least partial matches for each of the plurality of tokens.

In some embodiments, determining the weight of each of the plurality of tokens may be further based on the amount of at least partial matches.

According to some embodiments, based on the crime prediction data, the field data, and/or the predictive data, the method may determine one or more future crimes.

In some embodiments, generating the plurality of tokens may include normalizing the field data, such that the plurality of words within the field data are the same case. Further, the processor may remove the plurality of punctuation characters from the field data and convert the field data into the plurality of tokens. Next, the method may determine an amount of occurrences within the field data for each of the plurality of tokens. The corresponding amount of occurrences may be associated with each of the plurality of tokens. Additionally, a weight of each of the plurality of tokens may be determined based at least in part on the corresponding amount of occurrences. The corresponding weight may also be associated with each of the plurality of tokens.

These and other aspects of the present disclosure are described in the Detailed Description below and the accompanying figures. Other aspects and features of embodiments of the present disclosure will become apparent to those of ordinary skill in the art upon reviewing the following description of specific, example embodiments of the present disclosure in concert with the figures. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments of the disclosure discussed herein. In similar fashion, while example embodiments may be discussed below as device, system, or method embodiments, it is to be understood that such example embodiments can be implemented in various devices, systems, and methods of the present disclosure.

### BRIEF DESCRIPTION OF THE DRAWINGS

Reference will now be made to the accompanying drawings, which are not necessarily drawn to scale, are incorporated into and constitute a portion of this disclosure, illustrate various implementations and aspects of the disclosed technology, and, together with the description, serve to explain the principles of the disclosed technology. In the drawings:

FIG. 1 is a diagram of an example system for data analysis, in accordance with some examples of the present disclosure;

FIG. 2 is a component diagram of a user device, in accordance with some examples of the present disclosure;

FIG. 3 is a component diagram of a computing device, in accordance with some examples of the present disclosure;

FIG. 4 is an example flow chart of a method for data analysis, in accordance with some examples of the present disclosure; and

FIG. 5 is an illustration a plurality of tokens used by a neural network, in accordance with some examples of the present disclosure.

### DETAILED DESCRIPTION

Some implementations of the disclosed technology will be described more fully with reference to the accompanying drawings. This disclosed technology can be embodied in many different forms, however, and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods. Such other components not described herein can include, but are not limited to, for example, components developed after development of the disclosed technology.

It is also to be understood that the mention of one or more method steps does not imply that the methods steps must be performed in a particular order or preclude the presence of additional method steps or intervening method steps between the steps expressly identified.

Examples of the present disclosure may involve processing crime reports and mapping them into a feature vector space that automatically captures the similarity of incidents. The raw features extracted from the narratives using standard natural language processing (NLP) models (e.g., bag-of-words (BoW) model) are mapped into a latent feature vector space. Extraction may include data cleaning, tokenization, BoW, and Term Frequency-Inverse Document Frequency (TF-IDF). Data cleaning may involve normalizing the text to the same case, and removing stop-words, independent punctuation, low-frequency terms (low TF) and terms that appear in most of the crime reports. Tokenization may include converting the narrative of each of the crime reports into multiple word combinations, for example, a tri-gram. BoW may represent each crime report by one vector where each element means the occurrence in association with a specific term. As a result, the entire corpus may be converted to a term-document matrix and a dictionary that keeps the mapping between the terms and their identification. TF-IDF may be a numerical statistic that reflects how important a word is to a document in a collection or corpus. TF-IDF may extract feature vectors from the term-document matrix to de-emphasize frequent words. TF-IDF may be used to reduce the impact of the terms that appeared in most crime reports, which may mean they have weak discrimination capability across documents.

The Gaussian-Bernoulli Restricted Boltzmann Machines (GBRBMs) may be a type of neural network. The GBRBM may receive the TF-IDF for each incident. The GBRBM may be trained from a large number of data without supervision. After training, GBRBM may embed the crime incidents to capture the similarity of the incidents by vicinity in the Euclidean space. Further, the similarities may be visually mapped providing interactivity with a user.

Reference will now be made in detail to exemplary embodiments of the disclosed technology, examples of which are illustrated in the accompanying drawings and disclosed herein. Wherever convenient, the same references numbers will be used throughout the drawings to refer to the same or like parts.

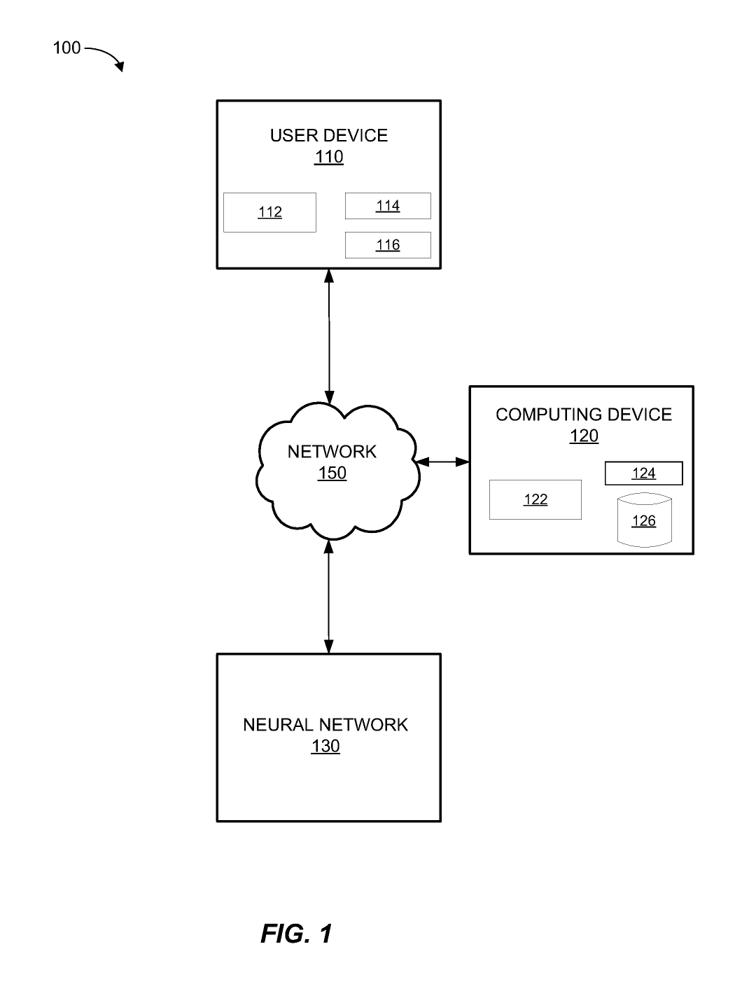

FIG. 1 shows an example system 100 that may implement certain aspects of the present disclosure. The components and arrangements shown in FIG. 1 are not intended to limit the disclosed embodiments as the components used to implement the disclosed processes and features may vary. As shown in FIG. 1, in some implementations the system 100 includes a user device 110, a computing device 120, a neural network 130, and a network 150. The user device 110 may include one or more processors 112, one or more transceivers 114, and a user portal 116. Additionally, computing device 120 may include one or more processors 122, one or more transceivers 124, and one or more databases 126.

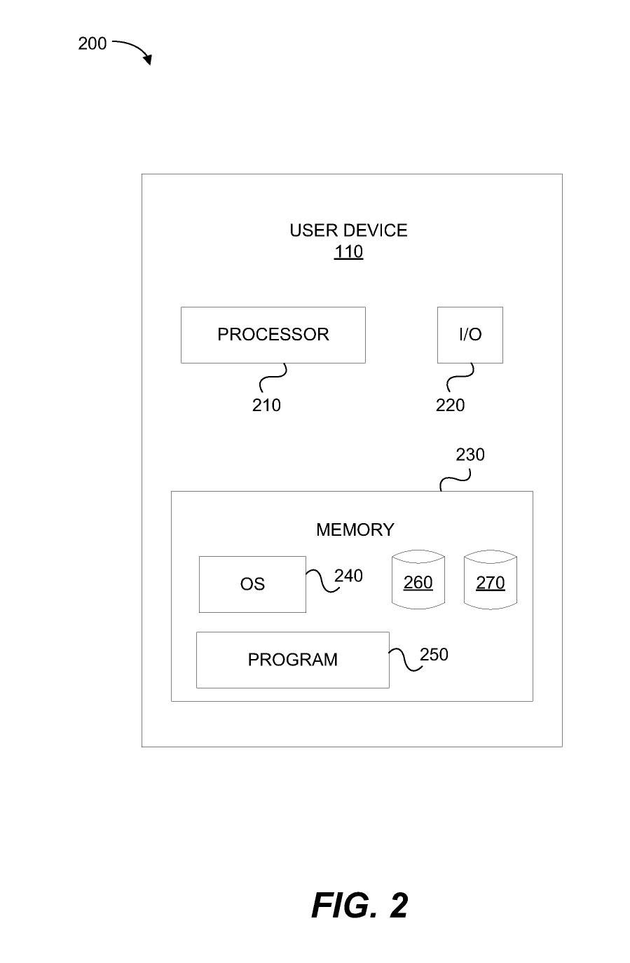

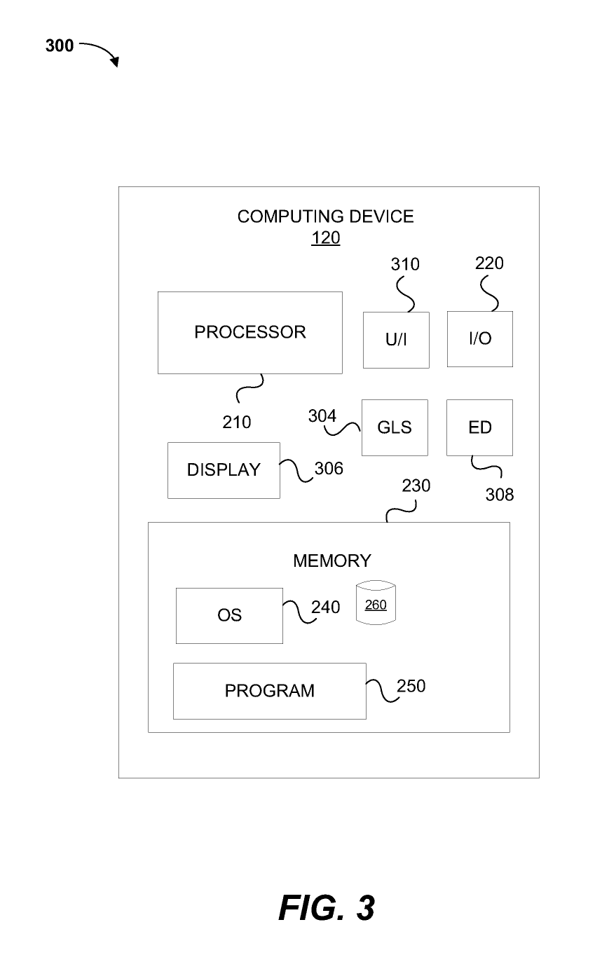

As non-limiting examples, the user device 110 may be a personal computer, a smartphone, a laptop computer, a tablet, or other personal computing device. Neural network 130 may include instructions and or/memory used to perform certain features disclosed herein. Network 150 may include a network of interconnected computing devices such as a local area network (LAN), Wi-Fi, Bluetooth, or other type of network and may be connected to an intranet or the Internet, among other things. Computing device 120 may include one or more physical or logical devices (e.g., servers) or drives and may be implemented as a single server or a bank of servers (e.g., in a “cloud”). An example computer architecture that may be used to implement user device 110 is described below with reference to FIG. 2. An example computer architecture with reference to FIG. 3 is described below. The example computer architecture may be used to implement computing device 120.

In certain implementations according to the present disclosure, processor 122 may transmit a report to user device 110. In some examples, a user may upload one or more reports to user device 110 via user portal 116.

The plurality of reports may be crime reports. Of course, the plurality of reports may include field data such as an incident time and/or an incident location (e.g., longitude and latitude, GPS coordinates, and/or a street address). The plurality of reports may further include narrative field data. Narrative field data may be provided by a police officer (e.g., handwritten) and it may describe an incident. Accordingly, narrative field data may include a plurality of words and/or punctuation characters. As expected, the narrative field data may include spelling errors, punctuation errors, irrelevant words or phrases, and/or slang terms.

User device 110 (e.g., processor 112) may extract field data from the plurality of reports. Further, processor 112 may identify a narrative field from each of the plurality of reports. Next, the processor 112 may extract narrative field data from the narrative field of each of the plurality of reports. Processor 112 may generate a plurality of tokens from the narrative field data. Generating the plurality of tokens may involve processor 112 normalizing the narrative field data such that the plurality of words within the narrative field data are the same case, removing the plurality of punctuation characters from the field data and/or narrative field data, and converting the field data and/or the narrative field data into the plurality of tokens. It may further include processor 112 determining an amount of occurrences within the narrative field data and/or the field for each of the plurality of tokens, and associating the corresponding amount of occurrences with each of the plurality of tokens. Additionally, processor 112 may determine a weight of each of the plurality of tokens based at least in part on the corresponding amount of occurrences, and associate the corresponding weight to each of the plurality of tokens. In some embodiments, processor 112 may compare each of the plurality of tokens to terms within a database (e.g., database 126) for at least a partial match, and calculate an amount of at least partial matches for each of the plurality of tokens. According to some embodiments, the amount of at least partial matches may be used, at least in part, to determine the weight of each of the plurality of tokens.

Transceiver 114 may send the plurality of tokens and/or the field data to neural network 130. Neural network 130 may use artificial intelligence/machine learning to determine correlations amongst the plurality of tokens and/or the field data. Based at least in part of the determined correlations, neural network 130 may generate and transmit predictive data to user device 110. In some embodiments, the predictive data may be crime prediction data. In some embodiments, processor 112 may determine one or more future crimes based on the crime prediction data and the field data. Determining future crimes, for example, may be performed by identifying specific crimes linked to associated crimes (e.g., retaliatory crimes). Further, future crimes may be determined based on assessing characteristics of a victim or a suspect. Certain characteristics, such as gang affiliation, may be indicative of previous participation in crime and/or willingness to engage in future crimes.

In some embodiments, a processor associated with another device (e.g., processor 122 associated with computing device 120) may receive the plurality of reports, identify the narrative field, extract the field data and/or narrative field data, generate the plurality of tokens, send the plurality of tokens and/or field data to neural network 130, receive predictive data from neural network 130, determine related crimes, and/or determine one or more future crimes, as described above in reference to user device 110.

According to some embodiments, processor 112 may determine related crimes based on the crime prediction data and the field data. Furthermore, processor 112 may plot the predictive data to map and generate a visual display of the map. Transceiver 114 may send the visual display to user portal 116. In turn, user portal 116 may display the visual display as a graphical user interface.

Turning to neural network 130, neural network 130 may reside on various computing devices including a laptop, a mainframe computer, or a server. Neural network 130 may reside on computing device 120, or on a device distinct from computing device 120. Neural network 130 may receive the plurality of tokens and/or the field data from user device 110, computing device 120, or another external device. In some embodiments, neural network 130 may be a GBRBM. Neural network 130 may determine correlations amongst the plurality of tokens and/or the field data. Based at least in part of the determined correlations, neural network 130 may generate predictive data. The predictive data may be transmitted by neural network 130 to user device 110, computing device 120, or another external device.

An example embodiment of user device 110 is shown in more detail in FIG. 2. As shown, user device 110 may include processor 210, input/output (“I/O”) device 220, memory 230 containing an operating system (“OS”) 240 and program 250. In some examples, user device 110 may comprise, for example, a cell phone, a smart phone, a tablet computer, a laptop computer, a desktop computer, a sever, or other electronic device. User device 110 may be a single server, for example, or may be configured as a distributed, or “cloud,” computer system including multiple servers or computers that interoperate to perform one or more of the processes and functionalities associated with the disclosed embodiments. In some embodiments, user device 110 may further include a peripheral interface, a transceiver, a mobile network interface in communication with processor 210, a bus configured to facilitate communication between the various components of user device 110, and a power source configured to power one or more components of user device 110.

A peripheral interface may include the hardware, firmware, and/or software that enables communication with various peripheral devices, such as media drives (e.g., magnetic disk, solid state, or optical disk drives), other processing devices, or any other input source used in connection with the instant techniques. In some embodiments, a peripheral interface may include a serial port, a parallel port, a general-purpose input and output (GPIO) port, a game port, a universal serial bus (USB), a micro-USB port, a high definition multimedia (HDMI) port, a video port, an audio port, a Bluetooth™ port, a near-field communication (NFC) port, another like communication interface, or any combination thereof.

In some embodiments, a transceiver may be configured to communicate with compatible devices and ID tags when they are within a predetermined range. The transceiver may be compatible with one or more of: radio-frequency identification (RFID), near-field communication (NFC), Bluetooth™, low-energy Bluetooth™ (BLE), WiFi™, ZigBee™, ambient backscatter communications (ABC) protocols or similar technologies.

A mobile network interface may provide access to a cellular network, the Internet, or another wide-area network. In some embodiments, a mobile network interface may include hardware, firmware, and/or software that allows processor(s) 210 to communicate with other devices via wired or wireless networks, whether local or wide area, private or public, as known in the art. A power source may be configured to provide an appropriate alternating current (AC) or direct current (DC) to power components.

As described above, user device 110 may be configured to remotely communicate with one or more other devices, such as computing device 120, neural network 130, and/or other external devices. According to some embodiments, user device 110 may utilize neural network 130 (or other suitable logic) to determine predictive data.

Processor 210 may include one or more of a microprocessor, a microcontroller, a digital signal processor, a co-processor or the like or combinations thereof capable of executing stored instructions and operating upon stored data. Memory 230 may include, in some implementations, one or more suitable types of memory (e.g. such as volatile or non-volatile memory, a random access memory (RAM), a read only memory (ROM), a programmable read-only memory (PROM), an erasable programmable read-only memory (EPROM), an electrically erasable programmable read-only memory (EEPROM), one or more magnetic disks, one or more optical disks, one or more floppy disks, one or more hard disks, one or more removable cartridges, a flash memory, a redundant array of independent disks (RAID), and the like), for storing files including an operating system, one or more application programs (including, for example, a web browser application, a widget or gadget engine, and or other applications, as necessary), executable instructions and data. In one embodiment, the processing techniques described herein are implemented as a combination of executable instructions and data within memory 230.

Processor 210 may be one or more known processing devices, such as a microprocessor from the Pentium™ family manufactured by Intel™ or the Turion™ family manufactured by AMD™ Processor 210 may constitute a single core or multiple core processor that executes parallel processes simultaneously. Processor 210 may be a single core processor, for example, that is configured with virtual processing technologies. In certain embodiments, processor 210 may use logical processors to simultaneously execute and control multiple processes. Processor 210 may implement virtual machine technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

User device 110 may include one or more storage devices configured to store information used by processor 210 (or other components) to perform certain functions related to the disclosed embodiments. In one example, user device 110 may include memory 230 that includes instructions to enable processor 210 to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

In one embodiment, user device 110 may include memory 230 that includes instructions that, when executed by processor 210, perform one or more processes consistent with the functionalities disclosed herein. Methods, systems, and articles of manufacture consistent with disclosed embodiments are not limited to separate programs or computers configured to perform dedicated tasks. User device 110 may include memory 230 including one or more programs 250, for example, to perform one or more functions of the disclosed embodiments. Moreover, processor 210 may execute one or more programs 250 located remotely from user device 110. For example, user device 110 may access one or more remote programs 250, that, when executed, perform functions related to disclosed embodiments.

Memory 230 may include one or more memory devices that store data and instructions used to perform one or more features of the disclosed embodiments. Memory 230 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational databases. Memory 230 may include software components that, when executed by processor 210, perform one or more processes consistent with the disclosed embodiments. In some embodiments, memory 230 may include image processing database 260 and neural-network pipeline database 270 for storing related data to enable user device 110 to perform one or more of the processes and functionalities associated with the disclosed embodiments.

User device 110 may also be communicatively connected to one or more memory devices (e.g., databases (not shown)) locally or through a network. The remote memory devices may be configured to store information and may be accessed and/or managed by user device 110. By way of example, the remote memory devices may be document management systems, Microsoft™ SQL database, SharePoint™ databases, Oracle™ databases, Sybase™ databases, or other relational databases. Systems and methods consistent with disclosed embodiments, however, are not limited to separate databases or even to the use of a database.

User device 110 may also include one or more I/O devices 220 that may include one or more interfaces (e.g., transceivers) for receiving signals or input from devices and providing signals or output to one or more devices that allow data to be received and/or transmitted by user device 110. User device 110 may include interface components, for example, which may provide interfaces to one or more input devices, such as one or more keyboards, mouse devices, touch screens, track pads, trackballs, scroll wheels, digital cameras, microphones, sensors, and the like, that enable user device 110 to receive data from one or more users.

In example embodiments of the disclosed technology, user device 110 may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

While user device 110 has been described as one form for implementing the techniques described herein, those having ordinary skill in the art will appreciate that other, functionally equivalent techniques may be employed. As is known in the art, some or all of the functionality implemented via executable instructions may also be implemented using firmware and/or hardware devices such as, for example, application specific integrated circuits (ASICs), programmable logic arrays, state machines, etc. Furthermore, other implementations of the first user device 110 may include a greater or lesser number of components than those illustrated.

FIG. 3 shows an example embodiment of computing device 120. As shown, computing device 120 may include input/output (“I/O”) device 220 for receiving data from another device (e.g., user device 110), memory 230 containing operating system (“OS”) 240, program 250, and any other associated component as described above with respect to user device 110. Computing device 120 may also have one or more processors 210, geographic location sensor (“GLS”) 304 for determining the geographic location of computing device 120, display 306 for displaying content such as text messages, images, and selectable buttons/icons/links, environmental data (“ED”) sensor 308 for obtaining environmental data including audio and/or visual information, and user interface (“U/I”) device 310 for receiving user input data, such as data representative of a click, a scroll, a tap, a press, or typing on an input device that can detect tactile inputs. User input data may also be non-tactile inputs that may be otherwise detected by ED sensor 308. For example, user input data may include auditory commands. According to some embodiments, U/I device 310 may include some or all of the components described with respect to I/O device 220 above. In some embodiments, environmental data sensor 308 may include a microphone and/or an image capture device, such as a digital camera.

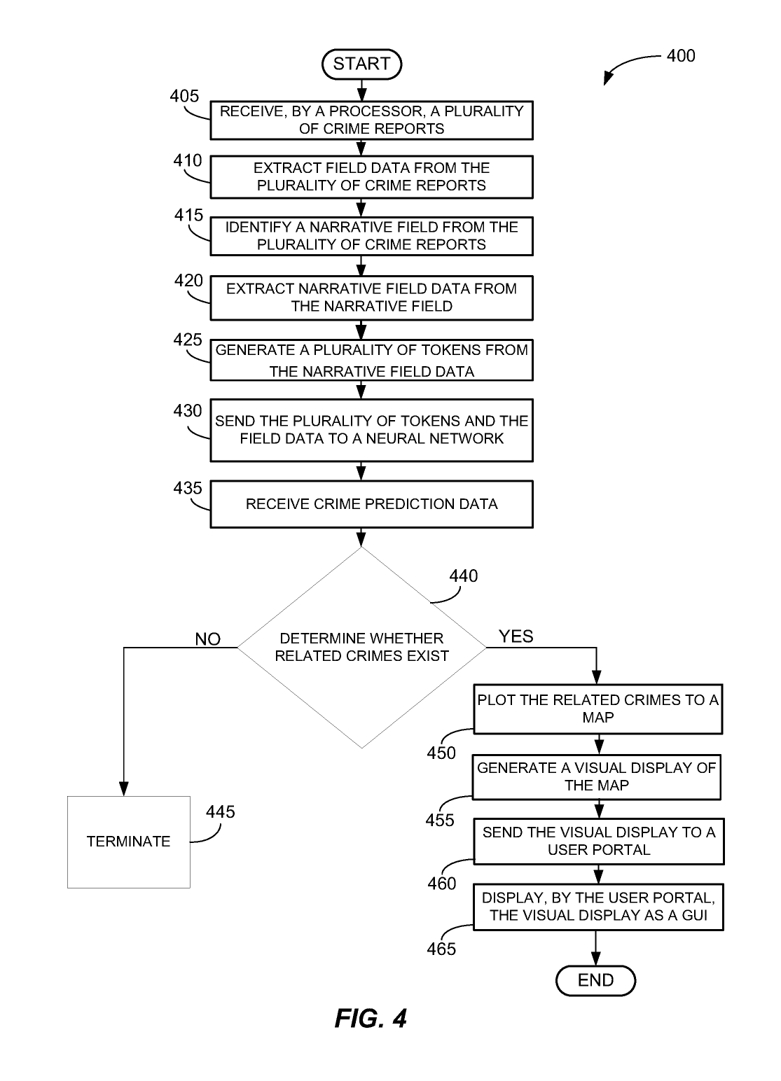

FIG. 4 illustrates an example flow chart of a method for data analysis. More specifically, the method may be used to determine related crimes from amongst a plurality of crime reports. At 405, the method may include processor 112 receiving a plurality of crime reports. In some embodiments, a user may upload the crime reports via user portal 116. It is also contemplated that processor 122 or another processor may receive the plurality of crime reports. At 410, field data may be extracted from each of the plurality of crime reports. The field data may include an incident time and/or an incident location. Further, at 415, the method may include identifying a narrative field from each of the plurality of crime reports, and at 420, extracting narrative field data from the narrative field of each of the plurality of crime reports.

At 425, the method may include generating a plurality of tokens from the narrative field data. The narrative field data may include a plurality of words and/or punctuation characters. Further, the narrative field data may include misspelled words, slang, and/or irrelevant words or phrases. Consequently, in some embodiments, generating the plurality of tokens may further include: normalizing the narrative field data, such that the plurality of words is the same case (e.g., all lowercase or all uppercase); removing the plurality of punctuation characters from the narrative field data; converting the narrative field data into a plurality of tokens; determining an amount of occurrences within the narrative field data for each of the plurality of tokens; associating the corresponding amount of occurrences with each of the plurality of tokens; determining a weight of each of the plurality of tokens based, at least in part, on the corresponding amount of occurrences; and associating the corresponding weight to each of the plurality of tokens. According to some embodiments, the plurality of tokens may include three-word combinations also known as a tri-gram term.

At 430, the method may include sending the plurality of tokens and/or the field data to neural network 130. Neural network 130 may determine correlations amongst the plurality of tokens and/or field data to generate crime prediction data. At 435, crime prediction data may be received from neural network 130. The method may further include, at 440, determining whether related crimes exist based on the crime prediction data. If the method determines related crimes do not exist, the method may terminate, at 445. At 450, in response to determining related crimes exist, the method may include plotting the related crimes to a map. At 455, a visual display of the map may be generated. The aforementioned steps may be performed in whole or jointly by user device 110, computing device 120, and/or other external devices.

At 460, the method may include sending the visual display to user portal 116. In some embodiments, transceiver 114 may send the visual display to user portal 116. At 465, user portal 116 may display the visual display as a graphical user interface.

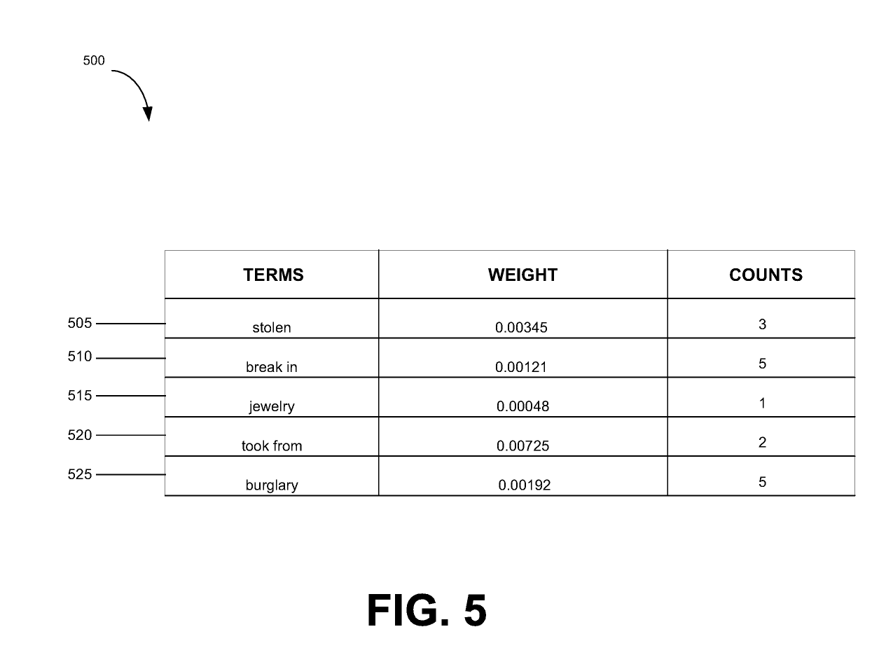

FIG. 5 illustrates a plurality of tokens used by neural network 130. As shown, the plurality of tokens may include multiple fields, for example, the fields may include a “TERMS” field, a “WEIGHT” field, and/or a “COUNTS” field. Rows 505, 510, 515, 520, and 525 may be representative of a token. The TERMS field may include a combination of words extracted from the narrative field data and/or the field data. The COUNTS field may indicate an amount of times the data in the TERMS field appeared in the plurality of crime reports. In some embodiments, the COUNTS field may also indicate an amount of times the data in the TERMS appeared in data within a crime database (e.g., database 126). In another embodiment, the COUNTS field may be based on a total of the amount of occurrences in the plurality of crime reports and within the crime database. Further, certain words or terms may be given a higher or lower weight. In some embodiments, words appearing infrequently may be given a higher weight while terms appearing frequently may be given a lower weight.

Throughout the specification and the claims, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

In this description, numerous specific details have been set forth. It is to be understood, however, that implementations of the disclosed technology can be practiced without these specific details. In other instances, well-known methods, structures and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described can include a particular feature, structure, or characteristic, but not every implementation necessarily includes the particular feature, structure, or characteristic. Further, repeated use of the phrase “in one implementation” does not necessarily refer to the same implementation, although it can.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and can include other examples that occur to those skilled in the art. Such other examples are intended to be within the scope of the claims if they have structural elements that do not differ from the literal language of the claims, or if they include equivalent structural elements with insubstantial differences from the literal language of the claims.

### Example Use Cases

The following example use case describes an example of a typical use of the systems and methods described herein for performing data analysis. It is intended solely for explanatory purposes and not for limitation. In one example, a local police department decides to solve crimes through a new automated technology. Police officers begin by scanning crime reports and uploading them to a computer (e.g., user device 110) in the crime stoppers division. The computer processes the crime reports by parsing the written report (e.g., narrative field data) and other data within the crime report (e.g., field data). The data from the crime reports are converted into multiple tokens and sent to an external device (e.g., neural network 130) for machine learning/artificial intelligence learning to be applied to the tokens. Through machine learning/artificial intelligence crime prediction data may be determined. The external device sends the crime prediction data to the police department's computer. A program within the computer uses the crime prediction data and the data obtained from the police reports to determine related crimes (same suspect). The related crimes are then displayed as a mapped graphical user interface on the computer.

What is claimed is:

1. A method for detecting crime series, the method comprising:
receiving, by one or more processors, a plurality of crime reports;
extracting, by the one or more processors, field data from each of the plurality of crime reports;
identifying, by the one or more processors, a narrative field from each of the plurality of crime reports;
extracting, by the one or more processors, narrative field data from the narrative field of each of the plurality of crime reports, wherein the narrative field data includes a plurality of words and a plurality of punctuation characters;
generating a plurality of tokens from the narrative field data;
sending, with a transceiver, the plurality of tokens and the field data to a neural network;
receiving, at the one or more processors and from the neural network, crime prediction data;
determining, by the one or more processors, based on the crime prediction data and the field data, related crimes;
plotting, by the one or more processors, the related crimes to a map;
generating, by the one or more processors, a visual display of the map;
sending, by the transceiver, the visual display to a user portal; and
displaying, by the user portal, the visual display as a graphical user interface.

2. The method of claim 1, wherein the field data includes at least one of an incident time or an incident location.

3. The method of claim 1, wherein generating the plurality of tokens further comprises:
normalizing, by the one or more processors, the narrative field data such that the plurality of words within the narrative field data are the same case;
removing, by the one or more processors, the plurality of punctuation characters from the narrative field data;
converting, by the one or more processors, the narrative field data into the plurality of tokens;
determining, by the one or more processors, an amount of occurrences within the narrative field data for each of the plurality of tokens;
associating, by the one or more processors, the corresponding amount of occurrences with each of the plurality of tokens;
determining, by the one or more processors, a weight of each of the plurality of tokens based at least in part on the corresponding amount of occurrences; and
associating, by the one or more processors, the corresponding weight to each of the plurality of tokens.

4. The method of claim 3, wherein each of the plurality of tokens include three-word combinations.

5. The method of claim 3, further comprising:
comparing, by the one or more processors, each of the plurality of tokens to terms within a database for at least a partial match; and
calculating an amount of at least partial matches for each of the plurality of tokens.

6. The method of claim 5, wherein determining the weight of each of the plurality of tokens is further based on the amount of at least partial matches.

7. The method of claim 1, further comprising:
determining, by the one or more processors, based on the crime prediction data and the field data, one or more future crimes.

8. A method for detecting patterns within data, the method comprising:
receiving, by one or more processors, a plurality of reports;
extracting, by the one or more processors, field data from amongst each of the plurality of reports, wherein the field data includes a plurality of words and a plurality of punctuation characters;
generating a plurality of tokens from the field data;
sending, with a transceiver, the plurality of tokens and the field data to a neural network; and
receiving, at the one or more processors and from the neural network, predictive data.

9. The method of claim 8, further comprising:
plotting, by the one or more processors, the predictive data to a map;
generating, by the one or more processors, a visual display of the map;
sending, by the transceiver, the visual display to the user portal; and
displaying, by a user portal, the visual display as a graphical user interface.

10. The method of claim 8, wherein each of the plurality of tokens includes a three-word combination.

11. The method of claim 8, wherein generating the plurality of tokens further comprises:
normalizing, by the one or more processors, the field data such that the plurality of words within the field data are the same case;
removing, by the one or more processors, the plurality of punctuation characters from the field data;
converting, by the one or more processors, the field data into the plurality of tokens;
determining, by the one or more processors, an amount of occurrences within the field data for each of the plurality of tokens;
associating, by the one or more processors, the corresponding amount of occurrences with each of the plurality of tokens;
determining, by the one or more processors, a weight of each of the plurality of tokens based at least in part on the corresponding amount of occurrences; and
associating, by the one or more processors, the corresponding weight to each of the plurality of tokens.

12. The method of claim 11, further comprising:
comparing, by the one or more processors, each of the plurality of tokens to terms within a database for at least a partial match; and
calculating an amount of at least partial matches for each of the plurality of tokens.

13. The method of claim 12, wherein determining the weight of each of the plurality of tokens is further based on the amount of at least partial matches.

14. The method of claim 8, wherein the plurality of reports are crime reports.

15. The method of claim 14, wherein the predictive data comprises related crime data.

16. The method of claim 15, further comprising:
determining, by the one or more processors, based on the predictive data, one or more future crimes.

17. A system for detecting crimes series comprising:
one or more processors;
a user portal;
a neural network;
a transceiver; and
at least one memory in communication with the processor, the user portal, the neural network, and the transceiver and storing computer program code that, when executed by the one or more processors, is configured to cause the system to:
receive, from the user portal, a plurality of crime reports;
extract field data from amongst each of the plurality of crime reports;
identify a narrative field from amongst each of the plurality of crime reports;
extract narrative field data from the narrative field of each of the plurality of crime reports, wherein the narrative field data includes a plurality of words and a plurality of punctuation terms;
generate a plurality of tokens from the narrative field data;
send, with the transceiver, the plurality of tokens and the field data to a neural network;
receive, from the neural network, crime prediction data;
determine based on the crime prediction data and the field data, related crimes;
plot the related crimes to a map;
generate a visual display of the map; and
send the visual display to a user portal, such that the visual display can be displayed by the user portal as a graphical user interface.

18. The system of claim 17, wherein generating the plurality of tokens further comprises:
normalize the narrative field data such that the plurality of words within the narrative field data are the same case;
convert the narrative field data into the plurality of tokens;
determine an amount of occurrences within the narrative field data for each of the plurality of tokens;
associate the corresponding amount of occurrences with each of the plurality of tokens;
determine a weight of each of the plurality of tokens based on the corresponding amount of occurrences and the amount of at least partial matches; and
associate the corresponding weight to each of the plurality of tokens.

19. The system of claim 18, further comprising:
compare each of the plurality of tokens to terms within a database for at least a partial match;
calculate an amount of at least partial matches for each of the plurality of tokens; and
wherein determining the weight of each of the plurality of tokens is further based on the amount of at least partial matches.

20. The system of claim 18, further comprising:
determining, by the processor, based on the crime prediction data and the field data, one or more future crimes.
